(19) United States
(12) Patent Application Publication
(10) Pub. No.: US 2026/0233122 A1
(43) Pub. Date: Aug. 13, 2026

(54) APPARATUS FOR INTENSE/RAPID COOLING AND FOR REMOVING A SUBSTANCE IN SUSPENSION IN A GASEOUS FLUID AND METHOD THEREOF

(71) Applicant: SNF Group, ANDREZIEUX-BOUTHEON (FR)

(72) Inventor: Danilo BOMBARDI, VAREDO (IT)

(21) Appl. No.: 19/156,664

(22) PCT Filed: Feb. 19, 2024
(86) PCT No.: PCT/EP2024/054202

§ 371 Date: Aug. 14, 2025

(30) Foreign Application Priority Data
Feb. 17, 2023 (IT) 102023000002760
Feb. 17, 2023 (IT) 102023000002763
Feb. 17, 2023 (IT) 102023000002766
Feb. 17, 2023 (IT) 202023000000588

(51) Int. Cl. B01D 5/00; B01D 53/00; B01D 53/26

(52) U.S. Cl. CPC B01D 5/0036; B01D 5/0006; B01D 5/0039; B01D 5/0051; B01D 5/0075; B01D 53/002; B01D 53/265; B01D 2257/7022; B01D 2257/708; B01D 2257/80; B01D 2258/06

(57) ABSTRACT

“An apparatus is provided for intense/rapid cooling and for removing a substance in suspension in a gaseous fluid. The apparatus has
a conveying means (2) with first and a second line (311, 321) operatively arranged in parallel
and a heat exchanger (4) for pre-cooling the gaseous fluid upstream of the first group (31) or second group (32).

The conveying means (2) has means (5) for transporting to the heat exchanger (4) the gaseous fluid that is present downstream of the first group (31) or second group (32) to remove heat from the gaseous fluid that is present upstream of the first group (31) or second group (32) and passes through the heat exchanger (4).

A directing means (6) directs the fluid alternatively towards the first or towards the second line (311, 321)
and a first fan (71) and a second fan (72) are situated along the conveying means (2).

The volumetric flow rate of the gaseous fluid generated by the first fan (71) is greater than the air flow rate generated by the second fan (72).

### TECHNICAL FIELD

The present invention relates to an apparatus for intense/rapid cooling and for removing a substance that is present in suspension in a gaseous fluid, typically air.

The substance is for example a pollutant (for example solvents such as volatile organic compounds, aliphatic compounds, hydrocarbons, oils, acids, etc.) or even simply moisture.

In particular, it is applied both in cryogenic treatments for intense cooling (for example of electronic components or semiconductors) or rapid cooling (for example of fluids downstream of an exothermic process), and for condensing a solvent or pollutant by separating it from a fluid in gaseous phase.

### PRIOR ART

There are known industrial applications of various kinds that make use of chemical substances. Purely by way of example: plastic material processing, printing, pickling, painting, pharmaceutical industries, etc. The chemical substances comprise solvents which are evacuated together with an air flow coming from the work zone. Before this air flow is released into the environment it must be treated. In this regard, there are known systems which entail cooling the air flow in order to facilitate the condensation of such substances. These substances could be in various forms, for example: vapours, gases, microdroplets, etc.

One drawback of such a solution is the operating discontinuity. In fact, during operation the pollutants are cooled and may freeze the path, progressively impeding correct operation. Therefore, periodic defrosting cycles of the refrigeration system or a part of the apparatus are provided for.

Another drawback is that the known solutions (incinerators, activated carbons . . . ) are normally too expensive and sometimes even ineffective.

A drawback of this solution is linked to the fact that with the use of evaporator-compressor-condenser-lamination cooling plants, it is difficult to obtain temperatures below −100° C.

The aim of the present invention is to eliminate the aforementioned drawbacks by making available an apparatus and a method that are capable of separating from a fluid in gaseous phase at least one solvent or pollutant, with low costs and constant yields.

Another aim is an easy recovery of the pollutants so that they can be stored and disposed of easily.

Another aim is to provide an apparatus for removing a substance in suspension in a gaseous fluid which allows maintenance operations to be made easier without penalising the continuity of operation.

Another aim is to allow an intense and rapid cooling.

### DESCRIPTION OF THE INVENTION

The invention relates to an apparatus for intense/rapid cooling and for removing a substance in suspension in a gaseous fluid, said apparatus comprising:
i) conveying means for conveying the gaseous fluid;
ii) a system for alternatively condensing/freezing or defrosting the substance present in the gaseous fluid comprising:
a first group of cooling or defrosting stages arranged in succession along a section of the conveying means;
a second group of cooling or defrosting stages arranged in succession along the conveying means;
means for collecting the substance;
the conveying means comprising a first and a second line operatively arranged in parallel; the first group of cooling or defrosting stages being located along the first line; the second group of cooling or defrosting stages being located along the second line;
iii) a heat exchanger for pre-cooling the gaseous fluid upstream of the first group or second group;
the conveying means comprising means for transporting to the heat exchanger the gaseous fluid that is present downstream of the first group or second group to remove heat from the gaseous fluid that is present upstream of the first group or second group and passes through the heat exchanger;
iv) directing means for directing the fluid alternatively towards the first or towards the second line, and
vi) a first fan and a second fan located along the conveying means;
the first fan being located upstream of said first and second groups of cooling or defrosting stages, the second fan being located downstream of said first and second groups, and the volumetric flow rate of the gaseous fluid generated by the first fan is greater than the air flow rate generated by the second fan.

Preferably, the first and the second lines converge in a connecting zone situated downstream of the first and second groups of cooling or defrosting stages; said first fan being located upstream of the directing means, said second fan being located downstream of the connecting zone.

Advantageously, the heat exchanger places in thermal communication:
a first zone of the conveying means situated upstream of the first and second groups of cooling or defrosting stages, with
a second zone of the conveying means situated downstream of the first and second groups of cooling or defrosting stages.

In a specific embodiment, the first group of cooling or defrosting stages comprises a first unit, a second unit and a third unit, and the second group of cooling or defrosting stages comprises a first unit, a second unit and a third unit, each couple of units (first units, second units, third units) comprising a cooling circuit, which comprises:
an evaporator of a working fluid, located in each unit;
a throttling valve for the working fluid, located in each unit;
a condenser of the working fluid, located outside the units and connected to each couple of units;
a compressor of the working fluid located outside the units and connected to each couple of units.

Preferably, the couple of third units further comprises subcooling means comprising advantageously a further compressor and a heat exchanger.

Preferably, the apparatus comprises cooling means for cooling the working fluid, said cooling means being interposed between the condenser and the throttling valve.

Advantageously, the cooling circuit comprises two receivers of a liquid phase of the working fluid, said two receivers being reciprocally in series and being situated downstream of the condenser and upstream of the throttling valve, along the direction of circulation of the working fluid in the cooling circuit.

In one embodiment, the cooling circuit comprises cooling means for cooling the working fluid, said cooling means being interposed between the condenser and the throttling valve.

In a specific embodiment, the first and second lines comprise:
a chamber situated along the gaseous fluid conveying means, advantageously after the first group and second group;
a refrigerant channel which is in thermal communication with the chamber in order to cool the gaseous fluid;
solid bodies situated inside the chamber;
an inlet port for the entry of the gaseous fluid into the chamber;
an outlet port for the exit of the gaseous fluid from the chamber.

Preferably, in at least one section of the refrigerant channel in thermal contact with the chamber there is gaseous nitrogen.

The refrigerant channel comprises, in preference, a coil that passes inside the chamber.

In a specific embodiment, the solid bodies occupy a space that surrounds the coil.

Preferably, the solid bodies comprise Raschig rings.

In some embodiments, the apparatus comprises a Stirling refrigerator, said Stirling refrigerator being situated downstream of a connecting zone of the first and second lines.

The Stirling refrigerator preferably comprises:
a cycle fluid;
a heat sink which dissipates the heat of the cycle fluid towards the outside of the Stirling refrigerator;
a cold zone in thermal communication with the gaseous fluid;
a line connecting the heat sink and the cold zone in which the cycle fluid moves;
means for compressing/expanding the cycle fluid.

Additionally, the invention concerns a method for intense/rapid cooling and for removing a substance in suspension in a gaseous fluid, comprising the steps of:
conveying the fluid within an apparatus comprising a first group of cooling or defrosting stages and a second group of cooling or defrosting stages, the first group of cooling or defrosting stages being located along a first line; the second group of cooling or defrosting stages being located along a second line said a first and a second line being operatively arranged in parallel;
directing the fluid alternatively towards the first or towards the second line, wherein a first fan situated upstream of said first and second groups of cooling or defrosting stages, generates a volumetric flow rate of the gaseous fluid greater than the air flow rate generated by a second fan situated downstream of said first and second of cooling or defrosting stages.

Advantageously, the first group comprises cooling stages while the second group comprises defrosting stages.

In a preferred embodiment, the first group or second group of cooling stages comprise at least a first, a second and a third stage, where:
the first stage allows for a temperature difference of about 10-30° C. and the elimination of moisture;
the second stage allows a temperature jump of about 40-50° C. compared to the temperature of the first stage;
the third stage allows a temperature jump of about 40° C. compared to the temperature of the second stage.

Additional features and advantages of the present invention will emerge more clearly from the approximate, and thus non-limiting, description of a preferred but not exclusive embodiment of an apparatus as illustrated in the appended drawings, in which:

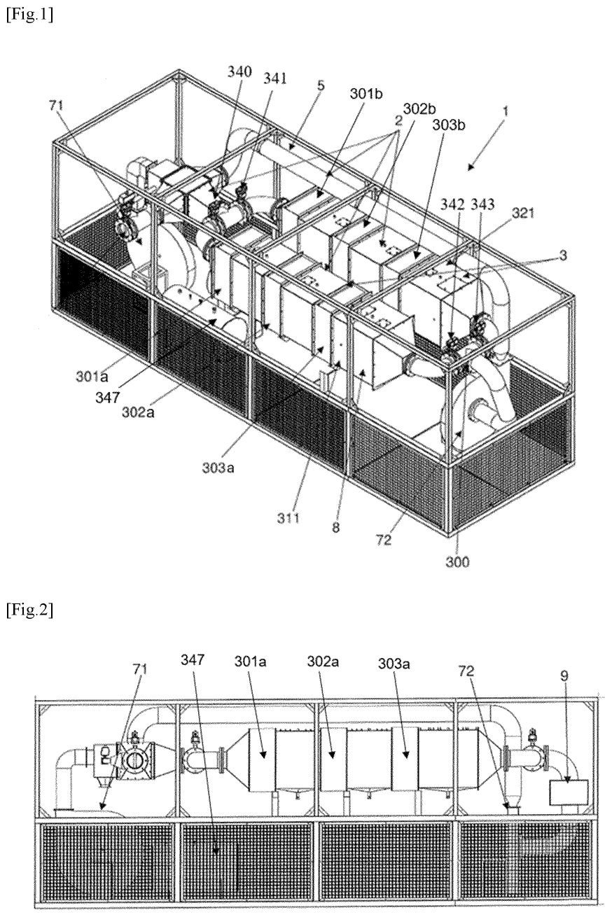

FIG. 1 shows a perspective view of an apparatus according to the present invention;

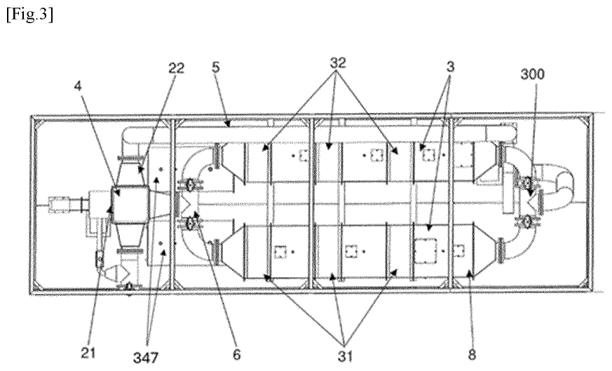

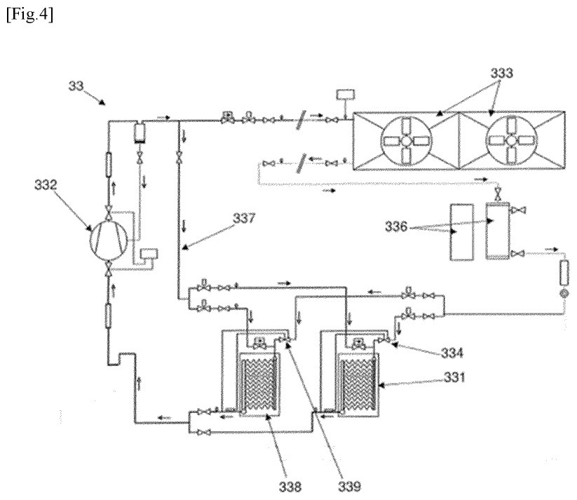

FIGS. 2 and 3 respectively show a side view and a plan view of the apparatus in FIG. 1;

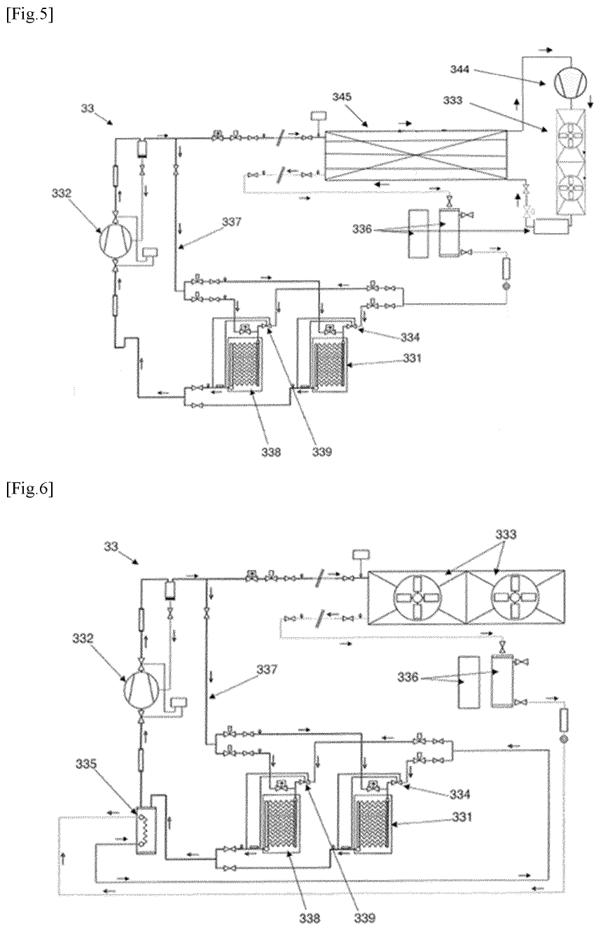

FIGS. 4 and 5 show a schematic representation of the cooling circuit according to one embodiment of the invention;

FIG. 6 show a schematic representation of the cooling circuit according to another embodiment of the invention;

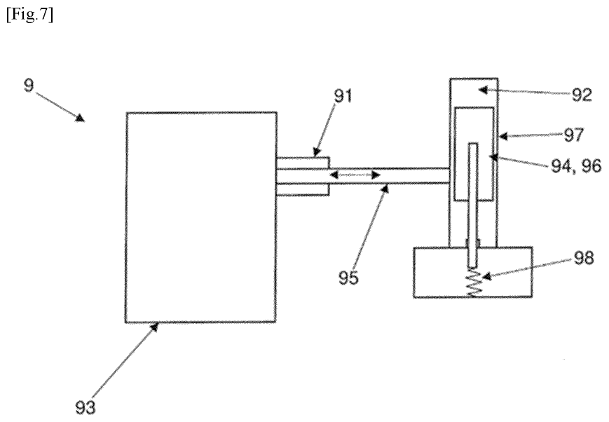

FIG. 7 shows a schematic representation of a Stirling refrigerator according to the invention;

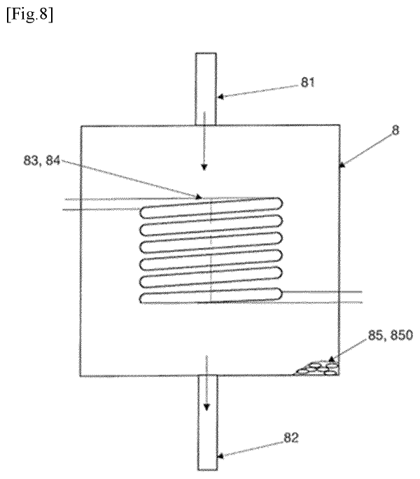

FIG. 8 shows a schematic representation of a chamber according to the invention.

In the accompanying figures, the reference number 1 denotes an apparatus for intense/rapid cooling and for removing a substance in suspension in a gaseous fluid.

The apparatus 1 allows the treatment of a gaseous fluid, preferably air to be cooled/condensed or to be treated for separating and recovering polluting agents, such as solvents (volatile organic compounds, aliphatics, hydrocarbons, oils, acids).

The apparatus 1 comprises conveying means 2 for conveying the gaseous fluid. The conveying means 2 typically comprises a set of conduits for conveying the gaseous fluid. The apparatus 1 comprises a system 3 for condensing/freezing the substance present in the gaseous fluid. The system 3 is located along the conveying means 2. The system 3 conveniently comprises a first group 31 of cooling or defrosting stages and a second group 32 of cooling or defrosting stages, arranged in succession along a section of the conveying means 2.

In the solution exemplified in FIG. 1, when working in the cooling mode, the first group 31 of cooling stages or the second group 32 of cooling stages, comprise at least a first, a second and a third stage. The stages of the first group 31 extend one after another in series.

Conveniently:
the first stage could allow for a temperature difference of about 10-30° C. and the elimination of moisture (for example the gaseous fluid could reach a temperature comprised between −5° and −10° C.);
the second stage could allow a temperature jump of about 40-50° C. compared to the temperature of the first stage (for example the gaseous fluid could reach a temperature of about
50°);
the third stage could allow a temperature jump of about 40° C. compared to the temperature of the second stage (for example the gaseous fluid could reach a temperature of about −100° C.).

In addition, or alternatively, the cooling or defrosting stages could comprise various refrigerators better described below and here only mentioned: Stirling cycle, chamber with coil, Raschig rings, etc. Such refrigerators are typically used to reach very low temperatures of the gaseous fluid. In particular configurations, the apparatus 1 also enables temperatures below −270° C. to be reached.

The system 3 also comprises means for collecting the substance 347. In fact, the condensed substance is then collected for evacuation. In at least one (but typically every) refrigeration stage a separator is provided to separate drops from the gaseous fluid; it can be of a turbulent nature or of another type. To facilitate the collection of the condensed substance, use can be made of a vacuum pump which draws the condensed substance into a collection tank. When ice is created, defrosting cycles will become necessary to enable periodic percolation of the solidified products.

The apparatus 1 comprises a heat exchanger 4 for pre-cooling the gaseous fluid. The heat exchanger 4 is intended to pre-cool the gaseous fluid upstream of the first group 31 second group 32 of cooling or defrosting stages. It is a gas-to-gas (or rather air-to-air) exchanger. For example, it could be a tube bundle heat exchanger 4 (in particular it could be a finned tube heat exchanger). In this regard, the conveying means 2 also comprises means 5 for transporting to the heat exchanger 4 the gaseous fluid that is present downstream of the first group 31 or second group 32 of cooling or defrosting stages. In this manner, heat is removed from the gaseous fluid that is present upstream of the first group 31 or second group 32 of cooling or defrosting stages and passes through the exchanger 4. In the exchanger 4, the gaseous fluid that is present downstream of the first group 31 or second group 32 is heated slightly before being released into the atmosphere (through a stack). This allows energy to be recovered.

In the heat exchanger 4, the gaseous fluid that is present upstream of the first group 31 or second group 32 and the gaseous fluid that is present downstream of the first group 31 or second group 32 conveniently do not mix (despite entering into thermal contact).

Conveniently, however, the heat exchanger 4 places in thermal communication:
a first zone 21 of the conveying means 2 situated upstream of the first and/or second group 31, 32 of cooling or defrosting stages, with
a second zone 22 of the conveying means 2 situated downstream of the first and/or second group 31, 32 of cooling or defrosting stages.

The conveying means 2 in fact comprises a first and a second line 311, 321 which are operatively arranged in parallel. The first group 31 of cooling or defrosting stages is located along the first line 311. The second group 32 of cooling or defrosting stages is located along the second line 321. In particular, the first and second lines 311, 321 are structurally identical.

The apparatus 1 comprises directing means 6 for directing the fluid alternatively towards the first or towards the second line 311, 321. The directing means 6 comprises means that direct the gaseous fluid towards the first or towards the second line 311, 321, for example, one or more valve, preferably two valves 340, 341.

The innovative presence of two lines 311, 321 in parallel, where in one of the lines a defrosting operation is performed whereas in the other line, an operation of cooling the gaseous fluid is performed, allows to ensure continuity of operation of the entire apparatus 1.

As exemplified in FIG. 1, the apparatus 1 comprises a first fan 71 and a second fan 72 situated along the fluid conveying means 2. The first fan 71 is preferably situated upstream of said first and second groups 31, 32 of stages. The second fan 72 is situated downstream of the first and second groups 31, 32 of cooling or defrosting stages. In at least one operating mode, the volumetric flow rate of the gaseous fluid generated by the first fan 71 is greater than the air flow rate generated by the second fan 72. In this regard, the apparatus 1 can comprise control means (not illustrated) for controlling the first and second fans 71, 72. In particular, the control means can regulate the operation of the first and second fans 71, 72 independently of each other. Such difference in the air flow rate creates an overpressure in the gaseous fluid.

The control means are used for controlling and regulating the fans 71, 72, connected to appropriate sensors, to control parameters of the fluid flow like for example temperature, speed, pressure, humidity, thereby appropriately regulating the fans for moving the fluid flow (rotation speed, inclination of the blades or other), also taking into account the variations in volume of the gaseous fluid within the apparatus in the various operating steps (ignition, transient, normal operation).

For example, the control means can adjust the rotation speed or drive torque or blade inclination of the first and/or second fans 71, 72. Typically, the first and/or second fans 71, 72 are centrifugal fans.

As exemplified in FIG. 1, the first and second lines 311, 321 converge in a connecting zone 300 situated downstream of the first and second groups 31, 32 of stages, past the chamber 8 and a pair of end valves 342 and 343. The first fan 71 is situated upstream of the directing means 6. The second fan 72 is situated downstream of the connecting zone 300.

Conveniently, the first group (31) of cooling or defrosting stages comprises a first unit (301a), a second unit (302a) and a third unit (303a), and the second group (32) of cooling or defrosting stages comprises a first unit (301b), a second unit (302b) and a third unit (303b), each couple of units (first units, second units, third units) comprising a cooling circuit (33), which comprises:
an evaporator (331, 338) of a working fluid, located in each unit (301a, 301b, 302a, 302b, 303a, 303b);
a throttling valve (334, 339) for the working fluid, located in each unit (301a, 301b, 302a, 302b, 303a, 303b);
a condenser (333) of the working fluid, located outside the units and connected to each couple of units;
a compressor (332) of the working fluid located outside the units and connected to each couple of units.

Advantageously, the couple of third units (303a, 303b) further comprises subcooling means comprising advantageously a further compressor (344) and a heat exchanger (345).

The working fluid preferably circulates in the cooling circuit 33. The working fluid could be freon or another refrigerant.

Advantageously, one of the two groups of cooling or defrosting stages 31, 32 operates as a cooler of the gaseous fluid while the other group 31, 32 of cooling or defrosting stages is frozen after the cooling operation and undergoes defrosting. These operations run in parallel.

FIG. 4 exemplifies a specific embodiment representing the cooling circuit 33 of the couple of first units 301a, 301b and the couple of second units 302a, 302b.

In reference to FIG. 4, when the gaseous fluid is cooled in the group 32 of cooling or defrosting stages, the working fluid circulating in the cooling circuit 33 of the couple of first units 301a, 301b and the couple of second units 302a, 302b, enters into the compressor 332 as a low-pressure liquid and leaves as a hot gas (for example, with a pressure of 32 bars). Thus, it flows into the condenser 333. The pressure of the working fluid gas is slightly reduced (for example, to 28 bars) and it is slightly cooled down.

Preferably, the cooling circuit 33 comprises two receivers 336 of a liquid phase of the working fluid, said two receivers 336 being reciprocally in series and being situated downstream of the condenser 333 and upstream of the throttling valve 339 along the direction of circulation of the working fluid in the cooling circuit 33. The receivers 336 prevent liquid slugging in the compressor 332.

The condensation of the gas can lead to the formation of liquid droplets which are stored in the two receivers 336. After flowing into the condenser 333, the gas is directed towards the throttling valve 339, where it is throttled to a lower pressure (for example 0.6 bars). Therefore, the fluid upstream of the throttling valve 339 is cooled to enhance performance in the subsequent throttling.

The working fluid flows into the evaporator 338, where it meets the gaseous fluid to be depolluted. The gaseous fluid cools down and the working fluid heats up. The evaporator 338 removes heat from the gaseous fluid that passes along the conveying means 2, which causes the working fluid gas to transition to liquid phase.

The working fluid flows into the compressor 332 and undergoes the same cycle.

In parallel, the other group 31 of cooling or defrosting stages is frozen and undergoes defrosting. The working fluid undergoes the compression in the compressor 332, then flows into the branch 337 to the throttling valve 334. There, the working gas fluid is throttled, and its pressure is reduced. It runs into the evaporator 331 to defrost it. In doing so, the frozen substance is liquefied and is collected in the means for collecting the substance 347. The working fluid gas is liquefied in the evaporator 331 and flows back into the compressor 332.

FIG. 5 represents the cooling unit 33 comprised in the couple of third units 303a, 303b, wherein one group 31 of cooling or defrosting stages is frozen and undergoes defrosting. The working fluid circulates in a similar way as described above by being compressed into compressor 332, then flowing into the branch 337 to the throttling valve 334. There, the working fluid is throttled, and its pressure is reduced. It runs into the evaporator 331 to defrost it, thus defrosting the substance. Then the working fluid flows back into the compressor 332. It flows into the heat exchanger 345, preferably a plate exchanger, where it comes in contact with a second working fluid circulating into a subcooling system.

The subcooling system, where circulates the second working fluid, comprises a compressor 344 and a condenser 333. Preferably, the second working fluid is of a different type than the working fluid compressed in the compressor 332.

The second working fluid passes through the compressor 344, then into the condenser 333 where it is cooled down. Then, it flows into the receiver 336 located downstream of the condenser 333. The fluid enters the heat exchanger 345 where it cools down the working fluid coming from the compressor 332. Afterwards, the second working fluid flows back into the compressor 344. This enables to cool even further the gas in the evaporator 338.

The working fluid that is cooled down flows into the receiver 336, then runs into the evaporator 338 to cool down the gaseous fluid to be treated.

In another embodiment of the invention, illustrated in FIG. 6, the cooling circuit comprises cooling means 335 for cooling the working fluid, said cooling means 335 being interposed between the condenser 333 and the throttling valve 334, 339.

The cooling means 335 allow to liquefy a fraction of working fluid still in gaseous phase. Then, the working fluid feeds into the compressor 332 and undergoes the same cycle as recited above.

In a particular embodiment, the first and second lines 311, 321 comprise:
a chamber 8 situated along the gaseous fluid conveying means 2, advantageously after the first group (31) and second group (32);
a refrigerant channel 83 which is in thermal communication with the chamber 8 in order to cool the gaseous fluid; in at least one section of the refrigerant channel 83 in thermal contact with the chamber 8 there is gaseous nitrogen;
conveniently, the refrigerant channel 83 comprises a coil 84 that passes inside the chamber 8;
solid bodies 85 situated inside the chamber 8, conveniently, the solid bodies 85 occupy a space that surrounds the coil 84;
an inlet port 81 for the entry of the gaseous fluid into the chamber 8;
an outlet port 82 for the exit of the gaseous fluid from the chamber 8.

Advantageously, the solid bodies 85 comprise Raschig rings 850. The solid bodies preferably increase the contact surface between liquid phase and gaseous phase of the fluid.

FIG. 8 illustrates only a portion of the solid bodies 85.

The chamber 8 is the last stage of refrigeration of the first and second groups 31, 32. It is therefore the stage closest to the connecting zone 300 which connects the first and second lines 311, 321.

In one particular embodiment, the apparatus 1 comprises a Stirling refrigerator 9. The Stirling refrigerator 9 is situated downstream of a connecting zone of the first and second lines 311, 321. In particular, the Stirling refrigerator 9 is located downstream of the connecting zone 300 of the first and second lines 311, 321. Therefore, it is located downstream of a zone in which the first and second lines 311, 321 are connected.

The Stirling refrigerator 9 comprises a cycle fluid, for example helium or another fluid. The cycle fluid does not undergo changes of state in the Stirling refrigerator 9.

As exemplified in FIG. 7, the Stirling refrigerator 9 also comprises a heat sink 91 which dissipates the heat of the cycle fluid towards the outside of the Stirling refrigerator 9. Conveniently, the heat sink 91 is a heat exchanger that dissipates for example towards outside air or water.

The Stirling refrigerator 9 further comprises a cold zone 92 in thermal communication with the gaseous fluid.

The Stirling refrigerator 9 further comprises a line 95 connecting the heat sink 91 and the cold zone 92. The cycle fluid moves in the line 95.

The Stirling refrigerator 9 further comprises means 93 for the compression/expansion of the cycle fluid.

The compression/expansion means 93 is a means of alternating movement of the cycle fluid along the connecting line 95. The means 93 enables a compression of the fluid in proximity to the heat sink 91 and an expansion of the fluid in the cold zone 92. Preferably, the compression/expansion means 93 comprises due pistons.

The connecting line 95 extends between the compression/expansion means 93 and the cold zone 92. The heat sink 91 is located along the line 95.

The Stirling refrigerator 9 comprises a regenerator 94 interposed between the heat sink 91 and the cold zone 92. The regenerator 94 exchanges heat with said cycle fluid. In particular, it absorbs heat and then returns it to the cycle fluid. The Stirling refrigerator 9 also comprises a displacer 96 interposed between the heat sink 91 and the cold zone 92. In particular, the displacer 96 and the regenerator 94 are integrated in a same mobile body. The displacer 96 can be shaped like a piston.

Conveniently, the heat sink 91 is interposed between the means 93 and the displacer 96. The displacer 96 is interposed between the heat sink 91 and the cold zone 92.

During operation the compression/expansion means 93 compresses the cycle fluid, which thus heats up. However, it transfers heat to the outside by means of the heat sink 91 and is partly cooled. The cycle fluid thus passes through the displacer 96/regenerator 94 and reaches the cold zone 92.

When passing through the regenerator 94, the cycle fluid transfers part of the heat to the latter. The compression/expansion means 93 cyclically brings about an expansion of the cycle fluid in the cold zone 92, thus bringing about a further cooling. The compression/expansion means 93 then draws back the cycle fluid, which on passing through the regenerator 94 takes back part of the heat previously transferred.

Therefore, the cycle fluid in the cold zone 92 removes heat from the gaseous fluid. The displacer 96 is situated along the connecting line 95. The displacer 96 moves in a seat 97 at one end of which the cold zone 92 is situated. The Stirling refrigerator 9 also comprises an elastic means 98, which draws the displacer 96 towards a predetermined position.

The present invention achieves important advantages.

First of all, it can facilitate maintenance and the correct operation of the apparatus. In fact, it is periodically necessary to defrost the first line 311, and in such a situation the operation of the second line 321 is possible and vice versa. Similarly, the positioning of the pre-cooling system upstream of the separation of the first and second lines allows for optimising the components, avoiding pointless redundancy. There is thus a studied distribution of the individual cooling components which enables a particular synergy.

Thanks to the chamber 8 and the two lines 311, 321 in parallel that can be activated alternatively, continuous operation of the apparatus is possible without interruptions as well as temperatures up to −176° C., as well as a reduction in costs compared to the solutions of the prior art. All of the details of the invention can be replaced by technically equivalent elements. All the materials used, as well as the dimensions, may in practice be any whatsoever according to needs.

1. An apparatus for intense/rapid cooling and for removing a substance in suspension in a gaseous fluid, said apparatus comprising:
i) conveying means for conveying the gaseous fluid;
ii) a system for alternatively condensing/freezing or defrosting the substance present in the gaseous fluid comprising:
a first group of cooling or defrosting stages arranged in succession along a section of the conveying means;
a second group of cooling or defrosting stages arranged in succession along the conveying means;
means for collecting the substance;
the conveying means comprising a first and a second line operatively arranged in parallel; the first group of cooling or defrosting stages being located along the first line; the second group of cooling or defrosting stages being located along the second line;
iii) a heat exchanger for pre-cooling the gaseous fluid upstream of the first group or second group;
iv) the conveying means comprising means for transporting to the heat exchanger the gaseous fluid that is present downstream of the first group or second group to remove heat from the gaseous fluid that is present upstream of the first group or second group and passes through the heat exchanger;
v) directing means for directing the fluid alternatively towards the first or towards the second line, vi) a first fan and a second fan located along the conveying means;
the first fan being situated upstream of said first and second groups the second fan being located downstream of said first and second groups and the volumetric flow rate of the gaseous fluid generated by the first fan being greater than the air flow rate generated by the second fan.

2. The apparatus according to claim 1, wherein the first and the second lines converge in a connecting zone situated downstream of the first and second groups of cooling or defrosting stages; said first fan being located upstream of the directing means, said second fan being located downstream of the connecting zone.

3. The apparatus according to claim 1, wherein said heat exchanger places in thermal communication:
a first zone of the conveying means situated upstream of the first and second groups of cooling or defrosting stages, with
a second zone of the conveying means situated downstream of the first and second groups of cooling or defrosting stages.

4. The apparatus according to claim 1, characterised in that the first group of cooling or defrosting stages comprises a first unit, a second unit and a third unit, and the second group of cooling or defrosting stages comprises a first unit, a second unit and a third unit, each couple of units, including said first units, second units, third units, comprising a cooling circuit, which comprises:
an evaporator of a working fluid, located in each unit;
a throttling valve for the working fluid, located in each unit
a condenser of the working fluid, located outside the units and connected to each couple of units;
a compressor of the working fluid located outside the units and connected to each couple of units.

5. The apparatus according to claim 4, wherein the couple of third units further comprises subcooling means comprising advantageously a further compressor and a heat exchanger.

6. The apparatus according to claim 4, wherein the cooling circuit comprises two receivers of a liquid phase of the working fluid, said two receivers being reciprocally in series and being situated downstream of the condenser and upstream of the throttling valve along the direction of circulation of the working fluid in the cooling circuit.

7. The apparatus according to claim 4, wherein the cooling circuit comprises cooling means for cooling the working fluid, said cooling means being interposed between the condenser and the throttling valve

8. The apparatus according to claim 1, wherein the first and second lines comprise:
a chamber situated along the gaseous fluid conveying means after the first group and second group;
a refrigerant channel which is in thermal communication with the chamber (8) in order to cool the gaseous fluid;
solid bodies situated inside the chamber;
an inlet port for the entry of the gaseous fluid into the chamber;
an outlet port for the exit of the gaseous fluid from the chamber.

9. The apparatus according to claim 8, wherein the solid bodies comprise Raschig rings.

10. The apparatus according to claim 1, wherein said apparatus comprises a Stirling refrigerator, said Stirling refrigerator being located downstream of a connecting zone of the first and second lines.

11. The apparatus according to claim 10, wherein said Stirling refrigerator comprises:
a cycle fluid;
a heat sink which dissipates the heat of the cycle fluid towards the outside of the Stirling refrigerator;
a cold zone in thermal communication with the gaseous fluid;
a line connecting the heat sink and the cold zone in which the cycle fluid moves;
means for compressing/expanding the cycle fluid.

12. A method for intense/rapid cooling and for removing a substance in suspension in a gaseous fluid, comprising the steps of:
conveying the fluid within an apparatus comprising a first group of cooling or defrosting stages and a second group of cooling or defrosting stages, the first group of cooling or defrosting stages being located along a first line; the second group of cooling or defrosting stages being located along a second line said a first and a second line being operatively arranged in parallel;
directing the fluid alternatively towards the first or towards the second line wherein a first fan situated upstream of said first and second groups of cooling or defrosting stages, generates a volumetric flow rate of the gaseous fluid greater than the air flow rate generated by a second fan situated downstream of said first and second groups of cooling or defrosting stages.

13. The method according to claim 12, wherein the first group comprises cooling stages while the second group comprises defrosting stages.

14. The method according to claim 12, wherein the first group or second group of cooling stages comprise at least a first, a second and a third stage, wherein
the first stage allows for a temperature difference of about 10-30° C. and the elimination of moisture;
the second stage allows a temperature jump of about 40-50° C. compared to the temperature of the first stage;
the third stage allows a temperature jump of about 40° C. compared to the temperature of the second stage.
